(19) United States
(12) Patent Application Publication
(10) Pub. No.: US 2014/0145955 A1
(43) Pub. Date: May 29, 2014

(54) SMART AIR MOUSE

(71) Applicants: David Gomez, Grenoble (FR); Martin Guillon, Grenoble (FR)

(72) Inventors: David Gomez, Grenoble (FR); Martin Guillon, Grenoble (FR)

(73) Assignee: MOVEA, Grenoble (FR)

(21) Appl. No.: 13/885,433

(22) PCT Filed: Nov. 11, 2011
(86) PCT No.: PCT/EP11/69688

§ 371 Date: Jul. 30, 2013

Related U.S. Application Data
(60) Provisional application No. 61/413,674, filed on Nov. 15, 2010.

(51) Int. Cl. G06F 3/0354; G06F 3/041

(52) U.S. Cl. CPC G06F 3/03547; G06F 3/041
USPC 345/163

(57) ABSTRACT

A smart handheld device with a touch screen which can be used as a 2D or 3D mouse to control applications running on a host device. The smart device can include an optical sensor for, when a motion capture mode is activated, automatically detecting that it lies on a surface, measuring displacements of the device on the surface and emulating displacements of a cursor on the screen of the host device. The smart device can include a two axes gyroscope which can, when the motion capture mode is activated, measure yaw and pitch of the device in free space and convert changes in orientation measurements into displacements of a cursor on the screen of the host device. The touch screen is divided into zones and sub-zones to control various applications running on the device or on the host. The zones are configurable through a graphical user interface.

### CROSS-REFERENCE TO RELATED APPLICATIONS

This application is the National Stage of International Application No. PCT/EP2011/069688, filed on Nov. 8, 2011, which claims the benefit of U.S. Application No. 61/413,674, filed on Nov. 15, 2010, the entire contents of which are incorporated herein by reference.

### BACKGROUND

The present invention deals with a man machine interface capable of sending commands to electronic devices. More specifically, it allows provisional transformation of different types of smart mobile devices, which have not been specifically designed for this purpose, into a specific device that can be used exactly like an air mouse and/or a remote control, taking also advantage of the ergonomics that are more and more common on said smart mobile devices.

Smart mobile devices include personal digital assistants, smart phones, specifically i-Phones™, and also i-Touch™, i-Pad™ and possibly some other multimedia storage and reproduction devices. These devices typically now include motion sensors (accelerometers and possibly gyroscopes and/or magnetometers), positioning sensors (GPS receiver), a digital camera, a Bluetooth and/or a Wifi link, a touch screen, a local processing power, etc. . . . The use of such devices by professionals, and the general public at large, has become very widespread and usage is very intensive. Users typically always carry their smart mobile device with them. By downloading a code on said device from an application store, they can have access to a quasi-infinite quantity of applications and content. Some of these applications take advantage of the motion and/or position capture potential of the smart mobile device but, to date, they have not gone as far as allowing the users of these smart mobile devices to get rid of other devices that they need to use for specific purposes, like an external mouse to replace the touch pad mouse of their portable computer, so that they are able to avoid carrying such a mouse with them, in addition to their smart mobile device. Also, while at home, the same professional has to use at least one other interface with his TV studio (and it is more likely that he will have to use at least two, one for the TV itself, another one for the set-top box). All these interfaces have their own weight, power consumption, ergonomics, software configurations, vendors, etc. . . . A PC mouse, which is generally used on a desk surface, cannot be used with a TV set and a TV remote control, which is generally moved in free space, cannot be used with a PC.

There is therefore a need for a universal man machine interface, which can be used as a remote command of all kind of electronic apparatuses, which would use all the possibilities offered by smart mobile devices. Some devices have been developed to this effect, but they fail to achieve integrated surface and free space control modes. They also fail to take full advantage of the capabilities of the current sensors and new features now available on smart mobile devices. The instant invention overcomes these limitations.

### SUMMARY

To this effect, the present invention provides a handheld device comprising at least one motion sensor and a touch screen, said device being capable of communicating signals from said sensor to a host device comprising a motion signals processing capability, wherein said touch screen of said handheld device comprises a number of touch zones which are operative to control at least an application running on said host device with movements of said handheld device on a surface or in free space, at the option of the user.

The invention also provides a method and a computer program to use said handheld device.

In a preferred embodiment, the smart mobile device comprises at least a two axes gyroscope, which allows precise pointing, recognition of the gestures of the user. In various embodiments, the touch zones emulate the usual buttons of a mouse (left, right, scroll wheel). More specifically, the scroll wheel is made to be emulated by a zone which may extend to the whole surface of the touch screen. Also, one of the touch zones can be used to transform the 2D mouse into a 3D mouse or remote control with the capability to directly control the movements of a cursor on the display of the host device or to send information on the gestures effected by the user of the handheld device which are then interpreted by the host device as commands of a number of preset functions. Furthermore, the touch zones on the screen of the handheld device can be made dependent on the application running in the foreground of the host device, which provides a lot of versatility to the device of the invention.

### BRIEF DESCRIPTION OF THE DRAWINGS

The invention will be better understood and its various features and advantages will become apparent from the description of various embodiments and of the following appended figures:

FIG. 1 represents a functional architecture to implement the invention;

FIG. 2 displays touch zones of the screen of a handheld device emulating buttons of a mouse according to various embodiments of the invention;

FIGS. 3a through 3c display different views of a touch zone of the screen of a handheld device emulating the scroll wheel of a mouse according to various embodiments of the invention;

FIGS. 4a and 4b represent a handheld device without and with a touch keyboard activated on the touch screen according to various embodiments of the invention;

FIGS. 5a through 5c represent three different views of the touch screen of the handheld device of the invention in different application contexts, according to various embodiments of the invention;

FIGS. 6a through 6c represent three different views of the touch screen of the handheld device of the invention to illustrate the 3D mode of the device, according to various embodiments of the invention;

FIG. 7 displays a help screen with the meanings of the swipe gestures in a specific context.

### DETAILED DESCRIPTION OF CERTAIN EMBODIMENTS

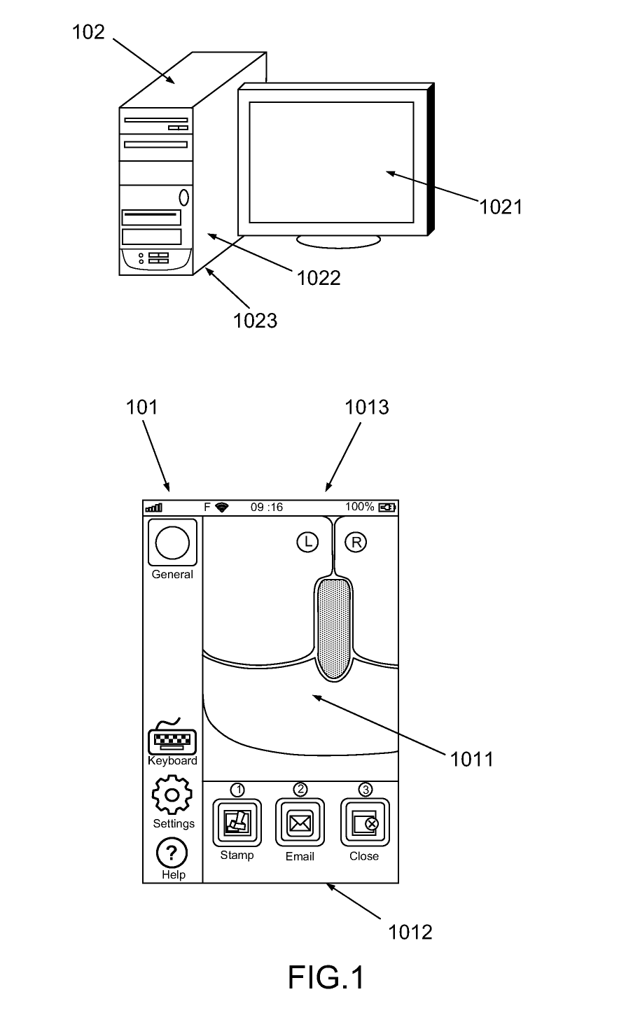

FIG. 1 represents a functional architecture to implement the invention.

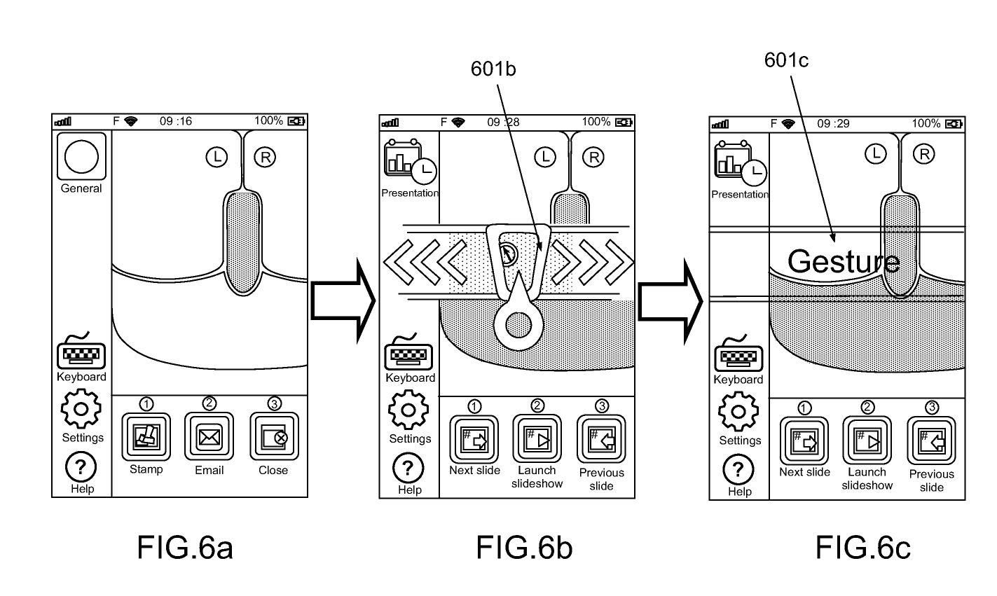

According to the invention, a smart mobile device, 101, is used to control applications running on a host device, 102, which has a display, 1021, on which a cursor can be used to select applications/functions by pointing/clicking on an icon or in a text scrolling list. Applications may also be controlled by predefined gestures of the user, as will be explained further below in the description in relation with FIGS. 6a through 6c.

Smart mobile devices generally have a touch screen, 1011. Smart mobile devices may be smart phones, such as an i-Phone™. In this case, a software application fit for implementing the invention can be downloaded by the users from the App Store™ for being installed as software element 1012, on the device 101. But the application may also be copied on the device from any storage medium. The invention can be implemented on any kind of smart mobile device, provided said device has a touch screen and at least one motion sensor, 1013, to measure the movements of the smart mobile device in space.

Motion sensor 1013 is preferably an inertial sensor such as an accelerometer or a gyroscope but can also be a magnetometer. Motion is at least measured along two axes. Micro Electrical Mechanical Systems (MEMS) sensors are more and more widespread and less and less costly. It may be useful to have a 2 axes gyroscope, to measure the pitch angle (or elevation, i.e., angle of the pointing device 101 in a vertical plane with the horizontal plane) and the yaw angle (or azimuth, i.e., angle of the pointing device 101 in a horizontal plane with the vertical plane) and a 2 axes accelerometer to correct these measurements from the roll movement (generally of the hand of the user carrying the device around his/her wrist). The movements of the smart mobile device 101 in a plane (2D) or in free space (3D) can then be converted into positions of a cursor on the screen of the host device 102. Also, as will be explained further below in the description, command signals can also be input in the smart mobile device 101 for controlling functions of the host device 102 which are to be executed at said positions of the cursor, by clicking on an icon or a text in a list.

Motion signals from the sensors and command signals input in the smart mobile device are transmitted to the host device 102 either using a wireless RF carrier (BlueTooth or WiFi) or using a wire connection, preferably to a USB port of the host device.

The host device 102, can be either a personal computer (desktop or laptop) or a set-top box in connection with a TV screen, 1021. The host device will run applications, 1023, such as multimedia applications (watching broadcast or cable TV or video film, listening radio or music . . . ), browsing the internet, processing e-mails, delivering presentations, etc. . . . It will also be equipped with a specific software, 1022, fit for implementing the invention. Such a software is MotionTools by Movea™. MotionTools includes routines to process the motion and command signals and map the movements and controls that they represent to positions and execution of functions of applications on the host device. The applications to be controlled can be pre-programmed by the user through a Graphical User Interface (GUI).

MotionTools is a software companion compliant with all the Movea peripherals and mice. It empowers the user with a suite of tools that allow taking full advantage of the mouse when in the air. When far from screen, the user can zoom in with MotionTools. When far from keyboard, the user may dispense from typing in most situations and ultimately will be able to display an on-screen keyboard in one click. MotionTools allows the user to link any action (zoom, on-screen drawing tool . . . ) to any mouse event (button click, mouse motion). The applications MotionTools can handle are grouped into categories or “contexts”:
“General”: no particular context (navigating on the disks, or every other applications which are not listed in the other contexts);
“Internet”: stands for web browsing applications (Firefox™, Google Chrome™ Safari™, Internet Explorer™, . . . );
“Multimedia”: stands for media players installed on the host device 102 like Windows Media Center™, iTunes™, . . . .
“Presentation”: stands for documents presentation software like Powerpoint™′ Keynotes™, . . . .

Other contexts can be added. The smart mobile device 101 is equipped with some additional media buttons and can generate recognized gesture events. MotionTools is highly configurable by the user. Profiles to perform configuration are defined. The user can save in these profiles the list of actions linked with specific mouse inputs or gesture events for each context, through a user-friendly GUI.

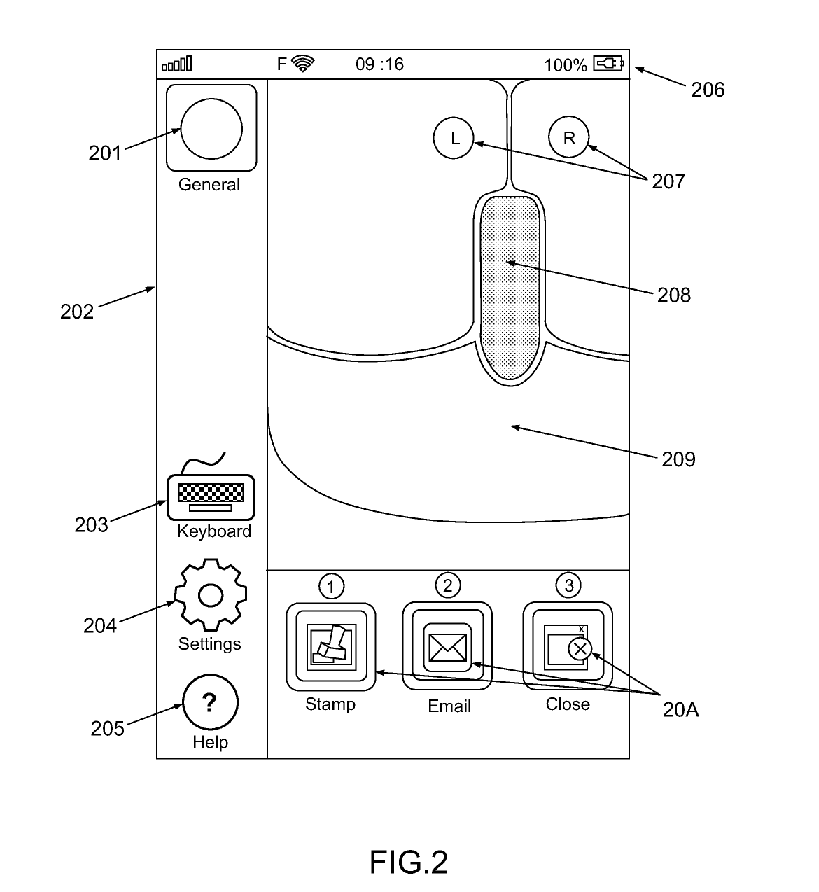

FIG. 2 displays touch zones of the screen of a handheld device emulating buttons of a mouse according to various embodiments of the invention.

The virtual mouse of the invention is activated using the standard command buttons/icons of the smart mobile device 101 on which the application of the invention has been installed.

The touch screen of the smart mobile device 101 according to the invention is divided in 4 main zones:
The left zone includes icons (201, 202, 203, 204, 205) for displaying or controlling features which do not change too frequently;
The upper zone displays the status (206) of the system functions of the smart mobile device;
The centre zone displays a mouse with its left and right buttons (207) to input click commands, a scroll wheel (208) and a specific button (209) to control the movements of the cursor on the screen of the host device when the smart mobile device is in a 3D control mode, and also to trigger activation of a gesture recognition mode;
The lower zones displays icons (20A) to control applications executed on the host device 102, depending on the contexts which are programmed in MotionTools.

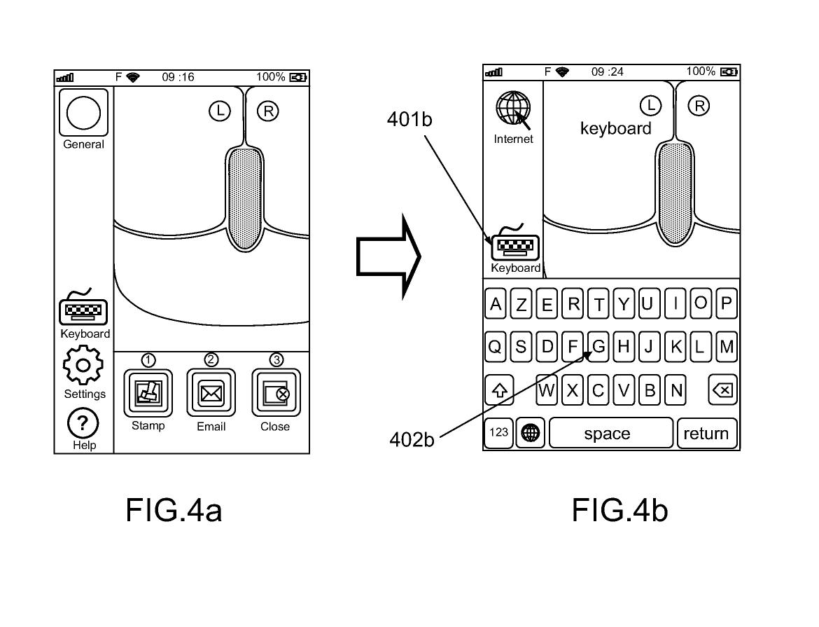

Icons 201 and 20A are context dependent: they vary with the applications which are executed in the foreground of the host device. Icons present in the left side bar may be programmed in MotionTools. The 202 zone allows more icons to be displayed. Icon 203 commands the display of a keyboard in the lower zone of the smart mobile device, as will be explained further below in the description in relation with FIGS. 4a and 4b. Icon 204 allows access to the settings of the device. Icon 205 allows access to a Help function.

The virtual mouse 207, 208, 209 allows input of the same commands which could be input with a physical mouse, whether this mouse is used in a 2D mode or in a 3D mode. This virtual mouse can replace an additional physical mouse that the user will be able to dispense of, if he does not want to carry the button or touchpad mouse of his laptop while travelling. This is advantageous because the smart mobile device may be plugged into the laptop through its USB connection for its battery to be re-powered while serving at the same time as a mouse.

The design of the virtual mouse is defined to be adapted to the manner a user normally holds a smart mobile device. A number of different designs can be provided to fit specific user requirements (left-handed users for instance), the selection of the desired design being made in the Settings.

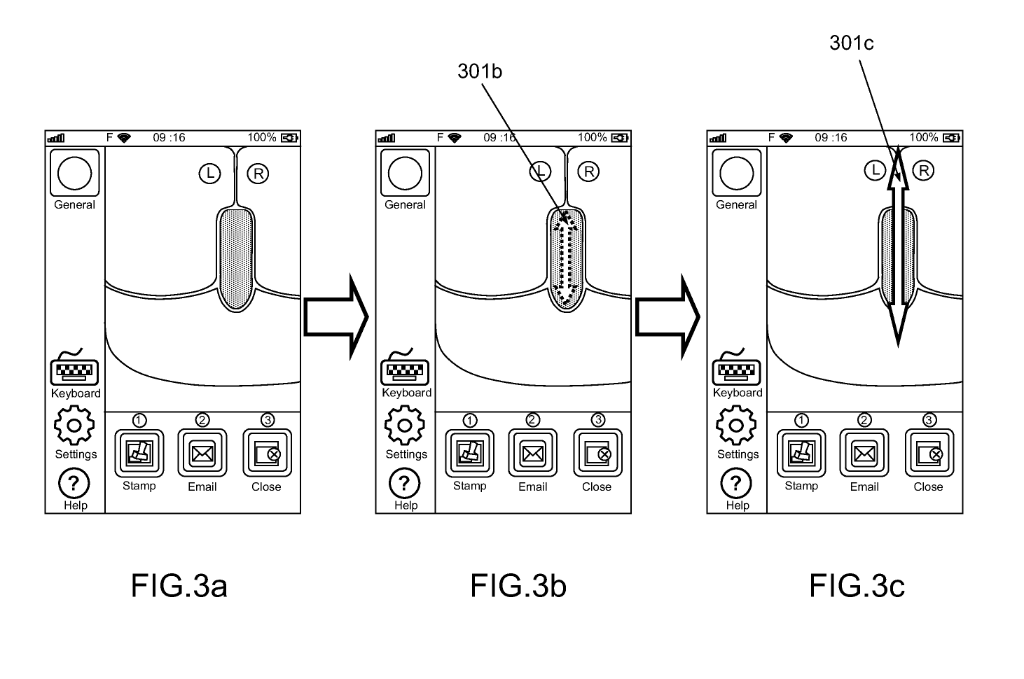

The functions performed by the left and right buttons (207) are normally the same as with a classical mouse (select and contextual menu). Operation of the scroll wheel 208 will be explained further below in the description in relation with FIGS. 3a, 3b and 3c. Operation of the control button 209 will be explained further below in the description in relation with FIGS. 6a, 6b and 6c.

FIGS. 3a through 3c display different views of a touch zone of the screen of a handheld device emulating the scroll wheel of a mouse according to various embodiments of the invention.

FIG. 3a is a view of the screen of the smart mobile device of the invention in a default/still mode (such as the one displayed on FIG. 2). The same would be true within an application context different from the general context which is displayed.

FIG. 3b exemplifies a situation where a user touches touch zone 208 of the virtual mouse of FIG. 2 with a finger like he would do with the scroll wheel of a physical mouse. A first arrow is displayed in said zone to confirm that the scroll wheel is active.

FIG. 3c represents a second arrow which, within a few tenths of seconds, replaces the first arrow to mark the direction along which the user must slide his finger to control the scroll in the host device application which is currently active.

The scroll function is deactivated when the user lifts his finger from the touch screen. The smart mobile device gets back to FIG. 3a, when in default/still mode.

FIGS. 4a and 4b represent a handheld device without and with a touch keyboard activated on the touch screen according to various embodiments of the invention.

The standard mode to activate a keyboard on a smart mobile device is to tap on a zone where text should be input. In the context of the invention, it is desirable to be able to activate a keyboard more simply, by tapping icon 401b. Virtual keyboard 402b will then be displayed over the lower touch zone of the touch screen of the smart mobile device. However, the place occupied by the virtual keyboard when displayed is defined so that it does not impeach any action on the control button 209. At the same time the Keyboard icon on the left is pushed up the screen to be still visible. Tapping again on icon 401b when the keyboard is active will cause it to disappear. It may also be possible to program a mouse command so that keyboard 402b is activated when the user clicks on a text input zone on screen 1021.

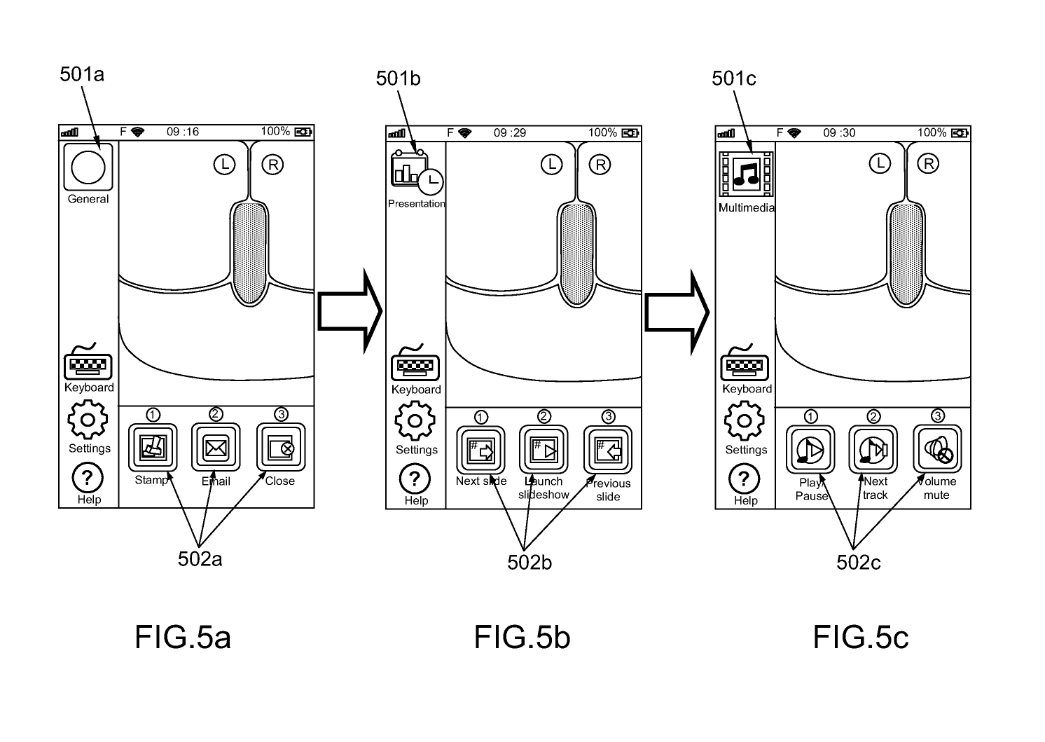

FIGS. 5a through 5c represent three different views of the touch screen of the handheld device of the invention in different application contexts, according to various embodiments of the invention.

More contexts can be added, using MotionTools.

FIG. 5a is a view of the screen of the smart mobile device of the invention in a default/still mode (such as the one displayed on FIG. 2). Icon 501a shows that the context which is active on the host device 102 is the General context. Simply by way of non limiting example, icons 502a represent three of the functions available in the general context:
The “Stamp” function allows the user to keep a number of images in permanent display on the screen of the host device 102, while other applications run as foreground process; the scroll wheel may be programmed so that, in the stamp mode, scrolling will allow to change from one stamped image to the other;
The “e-mail” icon is used to launch the default e-mail application which is installed on the host device;
The “Close” icon is used to exit application currently active in the foreground of the host device.

More than 3 buttons may be accessed, by sliding a finger in the lower zone rightwards/leftwards; many more functions can be accessed in this simple way. These general functions may be grouped in categories (for instance, “Display”, “Launch”, “Edition”, “Doc Browser”). This illustrates the advantages of the invention which gives the user access to much more than a remote control, indeed to a smart air mouse which can be used to control all functions of a host device in a very flexible and intuitive way, using a combination of commands which can be custom made by the user himself.

FIG. 5b represents the Presentation context, with an icon 501b to remind the user which is active in the foreground of the host device and icons 502b which are among the ones specific to this context (“Launch Slide Show”, “Next Slide”, “Previous Slide”).

FIG. 5c represents the “Media” context, also with icon 501c as a context reminder, and icons 502c which are buttons to respectively command “Play/Pause”, “Next Track” and “Volume/Mute”.

FIGS. 6a through 6c represent three different views of the touch screen of the handheld device of the invention to illustrate the 3D mode of the device, according to various embodiments of the invention.

Button 209 is used to control two specific functions of the virtual mouse. First, this button is used to control the cursor on the screen of the host device when the 3D mode is activated. The virtual mouse of the invention can operate in a 2D mode (classical positioning of the device in a x, y plane) or in a 3D mode wherein the pitch (respectively yaw) movements of the device are mapped to the vertical (respectively horizontal) movements of the cursor on screen 1021. When the device lies on a surface, the optical sensor of the camera of the device (which is preferably on the backside of the device) will detect that the device said laid down position and the 2D mode can be made automatically operative. The measurement of dx, dy in the plane is preferably the same as with an optical mouse using an optical sensor. When the device is taken off the table or the desktop and the user touches the ctrl button, the 3D mode is activated.

The cursor will be under the control of the smart mobile device 101 while there will be a contact of the user on touch zone 209. Then, the movements of the cursor will be determined by the yaw and pitch angles of the device 101, possibly corrected for unintended roll movements of the user, as explained above. When the user lifts his finger from button 209, the cursor stops moving. Alternatively, it is possible to program the virtual mouse controls so that the cursor control function is permanently active once button 209 has been tapped twice (deactivation being triggered by a single tap).

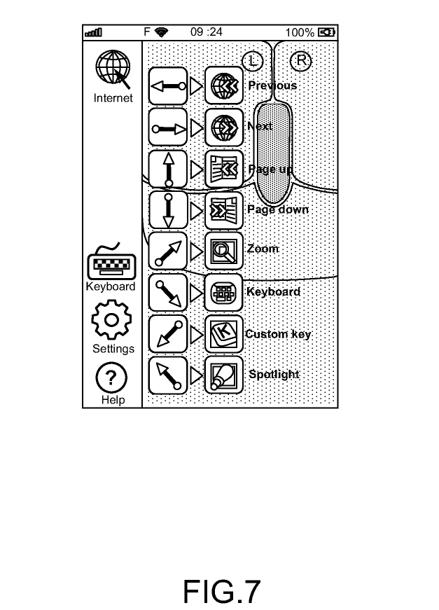

Button 209 is also used to trigger a specific gesture recognition mode. When the user taps the 209 touch zone, a horizontal coloured stripe will appear. Swiping the finger (preferably the thumb) along this stripe will activate a gesture recognition mode and lock the device in this mode while the thumb is in contact with the touch-screen. Once the thumb is leaving this button it unlocks the gesture recognition mode. Swipes are mapped to commands which are made to be context dependent as explained hereunder in relation with FIG. 7.

It is also possible to recognize more complex gestures, such as numbers, letters or any type of sign. To ensure that there are not too many false positives or false negatives, it may be necessary to include a database with classes of references gestures to which the gestures are compared to be recognized, using for instance Dynamic Time Warping or Hidden Markov Models algorithms. A simple processing of the movement vector will allow reconnaissance of swipes with enough reliability.

It is also possible to convert the roll and/or yaw and/or pitch angles of the smart mobile device into rotations of a virtual button and/or linear movement of a slider on the screen of the host device.

FIG. 7 displays a help screen with the meanings of the swipe gestures in a specific context.

The meanings of the swipes can be made dependent on the context running in the foreground of the host device. The context pictured on FIG. 7 in internet browsing. By way of example only, the following swipes are represented by eight arrows, from top to bottom:
Leftwards arrow: Previous;
Rightwards arrow: Next;
Upwards arrow: Page Up;
Downwards arrow: Page Down;
North-eastwards arrow: Zoom;
South-eastwards arrow: Keyboard;
South-westwards arrow: Custom key;
North-westwards arrow: Spotlight.

A number of features have to be programmed so as to make sure that there is no hazardous interaction between the virtual mouse function and the other functions of the smart mobile device. Some functions do not raise an issue, such as audio listening which can be carried out at the same time as the device is used as a virtual mouse. Phone calls may or may not be left to come in while the virtual mouse is operative. The default mode will be pausing the mouse when there is an incoming call. On usual smart phone this kind of notification is prioritized. When the call is finished, the smart phone will resume execution of the previously paused application. It is not possible to use the airplane mode because this deactivates all the radio capabilities of the device, Wifi/Bluetooth is normally needed this for communicating with the host.

It may also be necessary to deactivate the capability that an i-Phone has to rotate to adapt the format of the display. This will need to be done when programming the application.

The examples disclosed in this specification are only illustrative of some embodiments of the invention. They do not in any manner limit the scope of said invention which is defined by the appended claims.

1. A handheld device comprising at least one motion sensor and a touch screen, said device being capable of communicating signals from said sensor to a host device comprising a motion signals processing capability, wherein said touch screen of said handheld device comprises at least two touch zones which are operative to control at least an application running on said host device with movements of said handheld device on a surface or in free space, at the option of the user.

2. The handheld device of claim 1, wherein the at least one motion sensor is a gyroscope comprising at least two axes.

3. The handheld device of claim 2, wherein pitch and yaw orientation or displacement signals from said gyroscope are sent to the host device to be converted to two axes displacements of a cursor on a screen within an application running on the host device.

4. The handheld device of claim 3, further comprising a two axes accelerometer providing input to the motion signals processing capability to correct at least partially the roll of the handheld device.

5. The handheld device of claim 1, further comprising an optical sensor configured to trigger its operation in a surface motion capture mode when it detects that said handheld device lays down on a surface.

6. The handheld device of claim 5, wherein two axes position or displacement signals from said optical sensor are sent to the host device to be converted to two axes displacements of a cursor on a screen within an application running on the host device.

7. The handheld device of claim 1, wherein one of said at least two touch zones comprises at least three touch sub-zones, a first one of which is fit for switching from a surface motion capture mode to and from a free space motion capture mode, a second one being fit for performing a scroll command within the host application, the third one being fit for performing a select command within the host application.

8. The handheld device of claim 7, wherein the scroll and select commands within the host applications are programmable by a graphical user interface.

9. The handheld device of claim 7, wherein one of the touch sub-zones is also fit for switching to and from a gesture recognition mode.

10. The handheld device of claim 7, further comprising a fourth touch sub-zone which is configured to input context dependent commands to the host application.

11. The handheld device of claim 10, wherein the relative positioning of the four touch sub-zones can be changed to be suitable for use by a right-handed or a left-handed user.

12. The handheld device of claim 1, wherein one of said at least two touch zones comprises at least two touch sub-zones which control operation of host applications which are dependent on the context of the handheld device.

13. The handheld device of claim 12, wherein the at least two touch sub-zones which control operation of host applications which are dependent on the context of the handheld device are programmable by a graphical user interface.

14. The handheld device of claim 1, wherein one of said at least two touch zones comprises at least two touch sub-zones which control operation of said handheld device applications.

15. The handheld device of claim 1, further comprising a phone transmitter and receiver configured to be deactivated when said handheld device is in surface or free space motion detection mode.

16. A method for controlling at least an application running on a host device from a handheld device, said handheld device comprising at least one motion sensor and a touch screen and being capable of communicating signals from said sensor to a host device comprising a motion signals processing capability, wherein said method for controlling comprises steps of using motion of said handheld device on a surface or in free space at the option of a user and steps of commanding functions of said applications by said user touching zones of said touch screen.
